(19) United States
(12) Patent Application Publication
(10) Pub. No.: US 2017/0076099 A1
(43) Pub. Date: Mar. 16, 2017

(54) AN ACCESS METHOD AND APPARATUS FOR AN APPLICATION PROGRAM BASED ON AN INTELLIGENT TERMINAL DEVICE

(71) Applicant: BEIJING QIHOO TECHNOLOGY COMPANY LIMITED, Beijing (CN)

(72) Inventors: Tong YAO, Beijing (CN); Yi DING, Beijing (CN)

(73) Assignee: Beijing Qihoo Technology Company Limited, Beijing (CN)

(21) Appl. No.: 15/120,408

(22) PCT Filed: Dec. 11, 2014
(86) PCT No.: PCT/CN2014/093597

§ 371 Date: Aug. 19, 2016

(30) Foreign Application Priority Data
Feb. 21, 2014 (CN) 201410060982.3

(51) Int. Cl. G06F 21/62; G06F 21/53; G06F 21/56; G06F 21/51

(52) U.S. Cl. CPC G06F 21/62; G06F 21/51; G06F 21/53; G06F 21/562; G06F 2221/033

(57) ABSTRACT

The present invention provides an access method and apparatus for an application program based on an intelligent terminal device. The method comprises: after it is monitored that an installed application program performs a first access or an access that has ever been once denied of a behavior permission granted by an intelligent terminal device operating system, reading an application program authorization permission list preset for the application program by a user, wherein the behavior permission granted by the intelligent terminal device operating system is a behavior permission granted during the installation of the application program, and the application program authorization permission list comprises one or more behavior permission selectively authorized by the user for the application program; judging whether the behavior permission of the first access or the access that has ever been once denied matches any behavior permission authorized in the application program authorization permission list; and determining that the behavior permission of the first access or the access that has ever been once denied does not match any behavior permission authorized in the application program authorization permission list, denying to perform the first access of the behavior permission granted by the intelligent terminal device operating system by the application program. By applying the invention, the user security can be improved.

### TECHNICAL FIELD

The present invention relates to Android platform technologies, and in particular to an access method and apparatus for application program based on an intelligent terminal device.

### BACKGROUND

An Android platform is a Linux-based open source mobile phone operating system platform, consists of an operating system, a user interface and application programs, and is completely open to third-party application programs. Due to the openness of the Android platform, application program developers have a greater degree of freedom when developing application programs, therefore, many application program developers are attracted, and the application program developers also develop and provide a large number of Android application programs based on the Android platform. The installation package of such an application program is released in a form called APK (Android Package), and the running of the application program is implemented by installing the Android installation package, such that more and more application programs can be hosted on the Android platform. The Android platform, as the most popular mobile operating system platform in the world, has already covered billions of mobile terminals and numerous application programs.

At the beginning of its design, the Android platform designed a granted behavior permission based secure access policy, and when a user installs an application program, if the application program involves an operation relates to user security, for example, an operation of reading the user privacy information, or an operation that may result in loss of user fees, it requires the user to conduct behavior authorization for the application program before it proceeds. For example, if after installation, the application program needs to perform tan operation of reading user privacy information, such as sending a short message, accessing contact data and reading storage card data, or the like, or an operation that increases user fees, such as using a network connection, or the like, it needs to apply to the user for corresponding behavior permission during installation, that is, during the installation of the application program, a statement of the behavior permissions that need user authorization is shown to the user via a mobile terminal, and thereby the user determines whether to grant an access permission of performing a user security operation to the application program.

During the installation of the application program, due to the secure access strategy of the Android platform, when installing the application program, the user can only grant the behavior permissions applied for by the application program in general, therefore, when an application program is installed, after behavior permission services applied for by the application program are shown to the user, the user either accepts all the behavior permission services applied for by the application program to proceed to install the application program, or can only cancel the installation of the application program and exit the installation of the application program For example, when a user installs a KC network telephone application program, since relevant behavior permissions related to user security information need to be obtained, the Android platform displays, according to a behavior permission based secure access strategy, the security related behavior permissions that need to be authorized by the user in a display interface of a mobile terminal, for example, reading the state and ID of the mobile terminal, intercepting an outgoing call, directly calling a phone number, editing an SMS or MMS, and sending text information, audio recordings and precise GPS location information, etc. If the user authorizes the KC network telephone application program to perform all the above security operations, the installation can be continued by clicking on a Next control of the display interface. Thus, after the KC network telephone application program is installed, the KC network telephone application program will have permission to obtain the user security information, such as audio recording information and precise GPS location information, etc. of the user; and if the user does not authorize the KC network telephone application program to perform all the above security operations, he can exit the current installation of the KC network phone application program by clicking the Cancel control of the display interface.

Recently, utilizing the characteristic that the Android platform can only grant behavior permissions to an application program in general, malicious application programs for the Android platform increase significantly. In applying for user authorized behavior permissions, a malicious application program increases a plurality of behavior permissions that affect the user security, for example, behavior permissions of sending a short message, reading contacts, networking, recording audio, and reading the precise GPS location information of a user, and the like, binds to behavior permissions needed for the malicious application program to run normally, and attracts users to install with various attractive names, functions and applications, and meanwhile, when showing security related behavior permissions that need user authorization on the display interface of a mobile terminal, places the increased behavior permissions that affect the user security at a location that a user is less concerned about, and thereby continues with the installation by the user clicking the Next control of the display interface. However, once the malicious application program is installed and run, it implies that the user grants all the behavior permissions applied for by the malicious application program, which causes the user security to be confronted with significant risks, and yet the malicious application program achieves goals of stealing user privacy, malicious charging, and the like by its installation by the user. Further, even if the user doubts about some of the behavior permissions applied for by the malicious application program, he has no choice but to give up the installation.

To reduce potential security risks brought to a user by a malicious application program, the existing Android platform provides a secure application program for providing functions of active defense and behavior permission management, that is, by running the secure application program, the user may select behavior permissions that need to be disabled of individual application programs, thereby when an application program is running, it does not enjoy the behavior permissions granted by the user during installation of the application program, and thereby in a subsequent application, it may be avoided that the application program poses a threat to the user security. However, such an approach can not effectively avoid, in a period of time after the user installs the application program and before he sets disabled behavior permissions via the secure application program, the potential security risks brought to the user when the application program is running, the user security information can still be stolen or leaked out in this period of time, thereby bringing about a loss to the user and causing the user security to be lowered. Further, some application programs do have good experience points. However, since the user worries that the behavior permissions applied for by the application program might lead to leakage of personal privacy information, he will ultimately choose not to install the application program, which thus not only reduces the user's service experiences, but also brings great economic losses to the application program developer.

### SUMMARY OF THE INVENTION

In view of the above problems, the invention is proposed to provide an access method and apparatus for an application program based on an intelligent terminal device, a computer program and a computer readable medium, which overcome the above problem or at least partly solve the above problem.

According to an aspect of the invention, an access method for an application program based on an intelligent terminal device is provided, the method comprising:

after it is monitored that an installed application program performs a first access or an access that has ever been once denied of a behavior permission granted by an intelligent terminal device operating system, reading an application program authorization permission list preset for the application program by a user, wherein the behavior permission granted by the intelligent terminal device operating system is a behavior permission granted during the installation of the application program, and the application program authorization permission list comprises one or more behavior permission selectively authorized by the user for the application program;

judging whether the behavior permission of the first access or the access that has ever been once denied matches any behavior permission authorized in the application program authorization permission list; and

determining that the behavior permission of the first access or the access that has ever been once denied does not match any behavior permission authorized in the application program authorization permission list, denying to perform the first access of the behavior permission granted by the intelligent terminal device operating system by the application program.

According to another aspect of the invention, an access apparatus for an application program based on an intelligent terminal device is provided, the apparatus comprising: a monitoring module, a judgement module and a permission processing module, wherein

the monitoring module is configured to notify the judgement module after it is monitored that an installed application program performs a first access of a behavior permission granted by an intelligent terminal device operating system, the behavior permission granted by the intelligent terminal device operating system is a behavior permission granted during the installation of the application;

the judgement module is configured to read, according to the received notification, an application program authorization permission list preset for the application program by a user, and judge whether the behavior permission of the first access matches any behavior permission authorized in the application program authorization permission list, wherein the application program authorization permission list comprises one or more behavior permissions selectively authorized by the user for the application program; and

the permission processing module is configured to determine that the behavior permission of the first access does not match any behavior permission authorized in the application program authorization permission list, deny to perform the first access of the behavior permission granted by the intelligent terminal device operating system by the application program.

According to another aspect of the invention, a computer program is provided, comprising a computer readable code which causes the access method for an application program to be performed, when said computer readable code is run by an electronic device.

According to still another of the invention, a computer readable medium storing the computer program as described above is provided.

According to the access method and apparatus for an application based on an intelligent terminal device of the invention, before an application program is installed, behavior permissions that can be granted to the application program and behavior permissions that are forbidden to be granted can be preselected and determined, and after the application program is installed in the current authorizing in general manner, when the application performs a first access of an applied behavior permission, the applied behavior permission is matched with the preselected and determined behavior permissions, and if the applied behavior permission is not matched with the preselected and determined behavior permissions, the application program is denied to perform the access of the applied behavior permission or false data is returned, for example, with respect to a request for querying a GPS location of a user, the request can be directly denied or a method of returning a false location can be adopted. Thus, it solves the technical problem that, after the application program is installed in the authorizing in general manner, the application can also be forbidden to obtain authorizations of sensitive permissions from the user, so that the installed application program employs authorized permissions preset by the user to perform corresponding accesses, thereby achieving the beneficial effects of not only that the user normally uses the service functions provided by the application program can be ensured, but also the user security can be guaranteed effectively.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings of the embodiments are only for the purpose of showing the preferred embodiments, and are not considered to be limiting to the invention. And throughout the drawings, like reference signs are used to denote like components. In the drawings:

FIG. 1 illustrates the flow of an access method for an application program based on an intelligent terminal device of an embodiment of the invention; and

FIG. 2 illustrates a structure of an access apparatus for an application program based on an intelligent terminal device of an embodiment of the invention;

FIG. 3 illustrates a block diagram of an electronic device for performing a method according to the invention; and

FIG. 4 illustrates a schematic diagram of a storage unit for retaining or carrying a program code implementing a method according to the invention.

### DETAILED DESCRIPTION

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

In the prior art, when an application program is installed based on an intelligent terminal device, due to the characteristic that behavior permissions applied for by the application program can only be granted in general, a user can not select a behavior permission service according to his own security needs, and if he needs to install an application program, he can only be forced to accept all the behavior permissions applied for by the application program in behavior permission services that need the user to authorize displayed on the display interface of a mobile terminal to continue to install the application program. That is, by default, the user authorizes all the behavior permissions applied for by the application program, and thereby continues with the installation by the user clicking the Next control of the display interface. However, once the application program is installed and run, it implies that the user grants all the behavior permissions applied for by the application program, which causes the user security to be confronted with significant risks. However, the functions of active defense and permission management provided by a secure application program still can not effectively avoid potential security risks brought to the user due to running of an application program after the user installs the application program and before he set disabled behavior permissions via the secure application program, which causes the user security to be lowered.

Behavior permissions applied for by an existing application program to a user and configuration information of the application program are carried in a configuration information file of the application program. Since the configuration information file is generated by an application program developer via a signature, the behavior permissions applied for by the application program can not be changed by parsing the configuration information file and modifying the parsed configuration information file. In an embodiment of the invention, an access method for an application program based on an intelligent terminal device is proposed, in which, by obtaining in advance behavior permissions applied for by each application program, and selectively authorizing, by a user, the behavior permissions applied for by the application program, the user can perform corresponding selection and authorization in the behavior permissions applied for by the application program according to his own need of the functions of the application program and security considerations, to generate an application program authorization permission list. And after the application program is installed, when the application program performs a first access of an applied behavior permission, trigger the application program to take the generated application program authorization permission list as behavior permissions for performing accesses, thus it not only can ensure that the user normally uses the service functions provided by the application program, but also can guarantee the user security effectively.

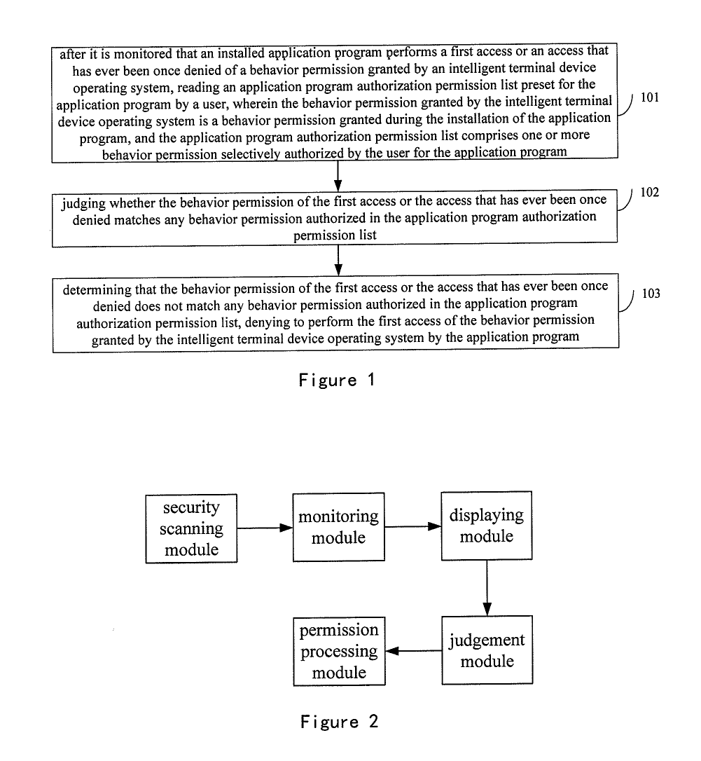

FIG. 1 illustrates a flow of an access method for an application program based on an intelligent terminal device of an embodiment of the invention. Referring to FIG. 1, the process flow comprises:

step 101, after it is monitored that an installed application program performs a first access of a behavior permission granted by an intelligent terminal device operating system, reading an application program authorization permission list preset for the application program by a user, wherein the behavior permission granted by the intelligent terminal device operating system is a behavior permission granted during the installation of the application program, and the application program authorization permission list comprises one or more behavior permission selectively authorized by the user for the application program.

In this step, based on a secure access strategy of the Android platform, the application program is installed in a manner of granting permissions applied for the application program in general, and the installation of the application program is a common technique, the detailed description of which is omitted here. In an embodiment of the invention, the flow of the installed application performing an access that has been once refused of an behavior permission granted by an intelligent terminal device operating system is the same as the flow of the first access.

The reading an application program authorization permission list preset by a user for the application program comprises:

A11, parsing an application program file package corresponding to the application program to obtain an application program identifier in the application program file package.

In this step, before being installed, each application program corresponds to an application program installation package, i.e. an application that can perform an access operation is obtained after the installation is performed using the application installation program package. By parsing the application program file package, the application program identifier for uniquely marking the application can be obtained.

A12, according to the obtained application program identifier, querying a preset application program authorization permission list library to obtain an application program authorization permission list corresponding to the application program identifier.

At this step, in the preset application program authorization permission list library, certain application program corresponds to an application program authorization permission list, and the application program authorization permission list takes the application program identification as a mark. In each application program authorization permission list are stored behavior permissions authorized in advance by a user for the application program. If the list has no behavior permissions corresponding to the application program, then there is no specific permission suggestion, however, the user still can authorize or disable all the permissions.

In an embodiment of the invention, the preset application program authorization permission list library can be obtained by the following approach:

for each application program, the following steps B11 and B12 are executed:

B11, collecting and obtaining behavior permissions applied for by the application program.

At this step, behavior permissions can be authorized for a certain application in advance before the application is installed. As an optional embodiment, an application program file package may be obtained via the official download website of the application program, or also the application program file package provided by a formal application program provider may be obtained from other approach. For example, the application program file package is obtained from an application program operator website. That is, the application program file package may be uploaded by an application program developer, or also may be uploaded by an application program operator, or also may be a legitimate copy of application program file package uploaded via other channel, as long as a legitimate copy of application program file package can be obtained. As such, by obtaining the application program file package via a formal approach, the legality and rationality of permissions applied for by the application program may be ensured, avoiding that after the application program file package is modified illegally via other approach, the illegally modified application program maliciously applies for more behavior permissions involving the user security.

After downloading and obtaining the application program file package, behavior permissions need to be applied for by the application program with respect to the intelligent terminal device operating system may be obtained by parsing the configuration information file in the application program file package.

In an embodiment of the invention, under the Android platform, the application program file package is an APK file. Each APK file comprises binary code information, resource information, a configuration information file, etc. of an application program. The configuration information file is an AndroidManifest.xml file in the APK file, must be defined and comprised by each application program, and it describes information of the name, version, permissions, referenced library files, etc. of an application program. In a practical application, parsing the configuration information file in an application program file package comprises: decompressing an application program file based on the Android platform, obtaining an encrypted configuration information file described by a global variable from the decompressed application program file, namely, an AndroidManifest.xml file, and decrypting the encrypted configuration information file to obtain a decrypted original configuration information file: an AndroidManifest.xml file; and scanning the permission description portion in the AndroidManifest.xml file, to obtain a list of behavior permissions applied for by the application program, wherein the behavior permissions comprised in the list of behavior permissions are behavior permissions applied for by the application program.

The form of a statement of the behavior permissions of the application program in the AndroidManifest.xml file is as follows:

File name: AndroidManifest.xml

<uses-permission android: name=“uses-permission”/>

As an optional embodiment, in the above parsing flow, the Extensible Markup Language (XML) file parser in Java may be used to parse the permission description portion in the AndroidManifest.xml file to obtain the list of behavior permissions applied for by the application program. Of course, it may also be possible to use other XML parser, or use other programming language, for example, a programming language such as C/C++, python, etc., to develop an XML parser, to parse the AndroidManifest.xml file to obtain the list of behavior permissions applied for by the corresponding application program.

B12, generating an application program authorization permission list stored in the application program authorization permission list library according to authorized behavior permissions selected by a user from the obtained behavior permissions applied for by the application program.

At this step, from behavior permissions applied for by each application program, according to his own business needs and the security considerations, the user respectively authorizes behavior permissions for each application, and generates, according to authorized behavior permissions selected for each application, the application program authorization permission list corresponding to the application program. Each application program corresponds to an application program authorization permission list, and the application program authorization permission list is marked with an application program identification. In an embodiment of the invention, a plurality of application program authorization permission lists constitute an application program authorization permission list library, and an application program authorization permission list not only comprises one or more behavior permission authorized by a user for an application program, but also comprises one or more behavior permission forbidden to be authorized by the user for the application program, and a behavior permission subsequently used for updating the application program meets the display of the application program authorization permission list interface. That is, for a behavior permission in an application program authorization permission list, its attribute is authorized or forbidden to be authorized, and authorized behavior permissions comprised in the application program authorization permission list are part of behavior permissions granted by the intelligent terminal device operating system. If a behavior permission that is applied for is in the application program authorization permission list, and its attribute is authorized, the behavior permission access applied for by the application program is allowed; and if a behavior permission that is applied for is in the application program authorization permission list, and its attribute is forbidden to be authorized, the behavior permission access applied for by the application program is denied.

As an optional embodiment, in order to facilitate the authorization and selection operation performed by the user on the behavior permissions, before the user selects an authorized permission from the obtained behavior permissions applied for by the application program, the method may further comprise:

displaying the obtained behavior permissions applied for by the application program.

At this step, an authorization setting interface is provided to the user, the behavior permissions applied for by the application program are displayed on the authorization setting interface, and the user makes authorization selection of a displayed behavior permission on the authorization setting interface. Thus, the user may conveniently select a needed behavior permission for authorization by means of the visual authorization setting interface.

As another optional embodiment, in order to improve the user's understanding of the behavior permissions applied for by the application program, the method can further comprise:

classifying the obtained behavior permissions applied for by the application program.

At this step, the obtained behavior permissions can be classified into privacy permissions and other permissions for each application program, wherein, for the privacy permissions, it is necessary to remind the user to pay special attention to involvement of the user's privacy, whereas for the other permissions, the user may, according to the application by the application program, grant the permissions to it without paying much attention.

In an embodiment of the invention, a privacy permission comprises, but is not limited to, the following information: sending a short message (android.permission.SEND_SMS), access to the internet (android.permission.INTERNET), reading a short message (android.permission.READ_SMS), writing a short message (android.permission.WRITE_SMS), reading contacts (android.permission.READ_CONTACTS), writing contacts (android.permission.WRITE_CONTACTS), calling a phone (android.permission.CALL_PHONE), writing system settings (android.permission.WRITE_SYNC_SETTINGS), reading location information, recording audio and reading audio recording information. Each privacy permission corresponds to a function. For example, for the permission to send a short message, the corresponding function is SmsManager.sendTextMessage, SmsManager.sendDataMessage, SmsManager.sendMultipartTextMessage, etc.

For the privacy permissions, they may be further divided into essential permissions and nonessential permissions. Therein, an essential permission is a behavior permission that is essential to the running of an application program and authorized by a user. If the authorized behavior permission is lacked, the application program can not be run normally. If the user needs to install the application program, he must authorize all the essential permissions applied for by the application program, otherwise, the installation can not be done. A nonessential permission is a behavior permission that is needed by an application program and authorized by a user, however, it is optional and will not affect the running of the application program. If the behavior permission is not authorized by the user, this will not affect the installation and the running of the application program. For example, the essential permissions may comprise: writing contacts, calling a phone, and the like, and the nonessential permissions may comprise: reading location information, access to the internet, reading audio recording information, and the like.

As an optional embodiment, for a nonessential permission, prompt information of the nonessential permission is further displayed to the user on the authorization setting interface. The prompt information may be: a nonessential permission, recommend to cancel, or the behavior permission is an optionally authorized item, authorize it according to your own security policy, or the like. That is, the user is suggested to carefully select a behavior permission granted to an application program based on his own privacy security considerations when authorizing nonessential permissions.

As a further optional embodiment, for essential permissions, verification can be further performed to determine whether all the essential permissions are essential to the running of an application program, that is, verification of legality and rationality is performed on the essential permissions applied for by the application program. An approach for verification may be utilizing an isolation sandbox and/or static code analysis and/or automatic code feature scanning, etc., to determine whether each behavior permission in the essential permissions is an indispensable behavior permission necessary for the application program to be run, and if not, the behavior permission is removed from the essential permissions and displayed to the user as a nonessential permission. Therein, by applying the static code analysis, the security risks and vulnerabilities existing in the essential permissions applied for by each application program can be found and located rapidly and accurately. And, by using the virtual machine technology, the isolation sandbox clones a certain partition or all partitions of a hard disk in the Android platform via a virtual machine, and forms a shadow, which is called a shadow mode. The shadow mode has the same architecture and functions as the Android platform system, and a user may run an application program in the shadow mode. Any operation of an application program, for example, deleting & modifying a file, installing & testing various application programs (including rogue application programs, virus application programs), is wrapped by the isolation sandbox, interception of user privacy information by a malicious application program is restricted within the isolation sandbox, and as soon as the isolation sandbox is closed, operations that endanger the Android platform can be erased. Therefore, by monitoring behaviors of accessing user data by an application program via the isolation sandbox approach, it may be determined whether the essential permissions applied for by the application program involve permission abuse, that is, whether the application program has applied to the user for a behavior permission that should not be applied for various purposes. If the application program has applied for an additional behavior permission by way of an essential permission, which may lead to leakage of the user privacy information, the behavior permission that has been applied for additionally needs to be removed from the essential permissions. For example, if a stand-alone game application program has applied for a permission to read a user's phone book, the reading a user's phone book might belong to a behavior permission that the stand-alone game application program should not applied for, which thus enhances the security of the user privacy. Utilizing an approach of isolation sandbox, static code analysis, and automatic code feature scanning, etc. to perform verification of legality and rationality on essential permissions applied for by an application program is a well-known technique, of which a detailed description will be omitted here.

As such, by classifying behavior permissions applied for by an application program into privacy permissions and other permissions, such that a user pays attention to a privacy permission involved therein, and thereby considers whether he needs to grant the permission to the application program, the user privacy security is guaranteed; further, by dividing the privacy permissions into essential permissions and nonessential permissions, such that for a nonessential permission, a user tries to avoid its authorization based on his own security policy, the user privacy security is thus improved; and moreover, for an essential permission, its verification of legality and rationality may remove behavior permissions additionally applied for by a malicious application program, the user security is guaranteed to the greatest extent.

As an optional embodiment, during the installation of the application program, the Android platform grants all the behavior permissions applied for by the application program, and when the installed application actually uses an access operation involved in the applied behavior permission for the first time, permission management is dynamically preformed to the application program by selecting a method of denying or returning false data according to the selection made by the user in advance for the application program. That is to say, it can find out a class and interface of a hook that needs to be inserted in the installation implementation of the application program in the source code of the framework level of the Android platform wherein such a class and interface are a class and interface involving the user privacy information. And by analysing and modifying source codes of the class and interface, the class and interface of the hook inserted when the configuration information file needs to be read are made to be directed to the application program authorization permission list preset by the embodiment of the invention, wherein the authorized behavior permissions comprised in the application program authorization permission list are a part of the behavior permissions granted by the intelligent terminal device operating system. In particular, the original default application program installer of the Android platform is replaced by way of modifying the source code, thereby implementing the reading of the application program authorization permission list of the embodiment of the invention, wherein an approach of replacing the original installer of the Android platform comprises, but is not limited to, the following: selecting by a user a new installer as the default installer of the Android platform, directly replacing the original application program installation solution of the Android platform on a Rooted mobile terminal, and replacing the original application program installation solution of the Android platform in the ROM of a mobile terminal.

Step 102, judging whether the behavior permission of the first access matches any behavior permission authorized in the application program authorization permission list.

Step 103, determining that the behavior permission of the first access does not match any behavior permission authorized in the application program authorization permission list, denying to perform the first access of the behavior permission granted by the intelligent terminal device operating system by the application program.

At this step, if the applied behavior permission is the same as any behavior permission in the application program authorization permission list, for example, as to performing audio recording and reading precise GPS location information, if the permissions for performing audio recording and reading the precise GPS location information are both allowed in the applied behavior permissions, while in the application program authorization permission list, the permission for performing audio recording is allowed and the permission for reading the precise GPS location information is forbidden. Then: the applied behavior permission for performing audio recording matches the behavior permissions for performing audio recording in the application program authorization permission list, and the applied behavior permission for reading the precise GPS location information does not match the behavior permission to read the precise GPS location information in the application authorization permission list. As to the condition of not matching, the access of the permission of the application program can be directly denied, or false data can be returned to the application program. For example, with regard to a request for querying precise GPS location information about the user, the Android platform can directly refuse the access of behavior permission of the application program, and can also return preset false GPS location information to the application program.

After the user installs the corresponding application program, if he needs to update some functions of the application program or the authorized permissions granted to the application program, the application program authorization permission list is run, the behavior permissions of each application program that need to be disabled or authorized can be selected by the user in an update interface corresponding to the application program authorization permission list, so as to modify the corresponding functions and the authorized permissions of the application program, thereby when the application program is rerun, the corresponding functions and the access of the authorized permission modified by the user can be supported. For example, if a certain authorized permission is disabled, when running again, the application program no longer enjoys the authorized permission disabled by the user. Accordingly, in an actual application, a corresponding counter can be set for each application program, and when it is monitored that an access of an applied behavior permission needs to be performed, the counter corresponding to the application program is read; and if a counting value of the counter is zero, this indicates that it the first time that the application program performs the access of the behavior permission. After the application performs the corresponding access of the behavior permission, one is added to the counting value of the corresponding counter. In subsequent applications, if the user updates the application program authorization permission list, the counting value of the corresponding counter is cleared to zero, and thus when the application program performs an access of the applied behavior permission again, the process flow matching the updated application program authorization permission list needs to executed.

As another optional embodiment, security scanning may further be performed on the application program file package before the application program file package is installed, to guarantee the security of the application program file package, and reduce the possibility of installing a malicious application program. As such, the method further comprises:

performing security scanning on the application program file package to be installed, and if the application program file package to be installed passes the security scanning, implementing the flow of installing the application program file package, otherwise, ending the flow.

At this step, deep security scanning is performed on the application program file package before installing the application program file package. The deep security scanning comprises, but is not limited to, Trojan virus scanning, adware scanning, and vulnerability scanning. For example, for the Trojan virus scanning, it can match the application program file package with features in a pre-stored malicious program library, and when the application program file package matches a feature in the malicious program library, prompt that the application program file package is a malicious program, and suggest the user to forbid installation of the application program. Thus, before installing an application program, a malicious application program may be recognized by performing deep security scanning on the application program file package to be installed, which greatly reduces the probability of mistakenly installing a malicious application program by a user.

In the embodiments of the invention, as an optional embodiment, the application program is installed according to a class and interface of a hook provided by the intelligent terminal device operating system, that is, the application program is installed according to the existing installation flow. After the installation of the application program is completed, and after it is monitored that the installed application program performs a first access of a behavior permission granted by the intelligent terminal device operating system, a third-party software for installing an application program based on an intelligent terminal device provided by the embodiments of the invention triggers the loading an application program authorization permission list preset by a user for the application program, such that the intelligent terminal device operating system updates behavior permissions granted to the application program with respect to the intelligent terminal device operating system during the installation according to authorized behavior permissions comprised by the loaded application program authorization permission list, i.e. judges whether the behavior permission (the behavior permissions granted by the intelligent terminal device operating system during the installation of the application program) of the first access matches any behavior permission authorized in the application program authorization permission list.

It can be seen from the above that, in the access method for an application program based on an Android platform of the embodiments of the invention, a user preselects and determines behavior permissions that can be granted to an application program and behavior permissions that are forbidden to be granted, and after the application program is installed, and when the installed application program needs to perform an access of an applied behavior permission during the installation, the applied behavior permission is matched with the behavior permissions that the user preselects and determines, and corresponding operations according to the matching result are executed. In this way, for some sensitive behavior permissions, for example, the behavior permissions of sending a short message and reading contacts, the user can prohibit, the application program from obtaining the authorization from the user for the sensitive behavior permissions before the application program is installed, and employs the authorized permissions selected and determined by the user before the application was installed to perform permission management on the behavior permissions of the application after the application is installed. Therefore, even if the user accidently installs and runs a malicious application program, since corresponding behavior permissions have been disabled by the user after the installation and before the application program is run, the loss of the potential security risks may be minimized, and the security of the Android platform may be increased effectively. Specifically, the embodiments of the present invention have a permission management mechanism before installation, that is, before an application is installed, a user may grant selected behavior permissions to the application program; a behavior permission access control mechanism, in which when the application performs an access of the applied behavior permissions for the first time, it needs to match the behavior permissions preset by the user; and a permission management mechanism after installation, that is, after the installation of the application is completed, the user is allowed to perform permission modification on the behavior permissions granted to the installed application program, and store the modified authorized permissions for the application program for conducting corresponding access by the application program according to the modified permissions when it is run.

FIG. 2 illustrates the structure of an access apparatus for an application program based on an intelligent terminal device of an embodiment of the invention. Referring to FIG. 2, the apparatus comprises: a monitoring module, a judgement module and a permission processing module, wherein

the monitoring module is configured to notify the judgement module after it is monitored that an installed application program performs a first access of a behavior permission granted by an intelligent terminal device operating system, the behavior permission granted by the intelligent terminal device operating system is a behavior permission granted during the installation of the application;

the judgement module is configured to read, according to the received notification, an application program authorization permission list preset for the application program by a user, and judge whether the behavior permission of the first access matches any behavior permission authorized in the application program authorization permission list, wherein the application program authorization permission list comprises one or more behavior permissions selectively authorized by the user for the application program; and

the permission processing module is configured to determine that the behavior permission of the first access does not match any behavior permission authorized in the application program authorization permission list, deny to perform the first access of the behavior permission granted by the intelligent terminal device operating system by the application program.

In an embodiment of the present invention, the judgement module comprises: a parsing unit, a querying unit and a judgement unit (not shown in the figure), wherein

the parsing unit is configured to parse an application program file package for installing the application program to obtain an application program identifier in the application program file package.

In an embodiment of the invention, obtaining behavior permissions applied for by the application program comprises: obtaining the application program file package via the official download website of the application program; and parsing the configuration information file in the application program file package and obtaining behavior permissions that the application program needs to apply for. Therein, the parsing the configuration information file in the application program file package comprises: decompressing an application program file based on the intelligent terminal device, obtaining an encrypted configuration information file described by a global variable from the decompressed application program file, and decrypting the encrypted configuration information file to obtain a decrypted original configuration information file, and scanning the permission description portion in the decrypted original configuration information file utilizing the extensible markup language file parser in Java.

The querying unit is configured to query, according to the obtained application program identifier, a preset application program authorization permission list library to obtain an application program authorization permission list corresponding to the application program identifier.

In an embodiment of the invention, setting an application program authorization permission list library comprises: for each application program, collecting and obtaining behavior permissions applied for by the application program; and generating an application program authorization permission list stored in the application program authorization permission list library according to behavior permissions selected by a user from the obtained behavior permissions applied for by the application program. Each application program corresponds to an application program authorization permission list, and a plurality of application program authorization permission lists constitute an application program authorization permission list library.

The judgement unit is configured to judge whether the behavior permission of the first access matches any behavior permission authorized in the obtained application program authorization permission list.

Preferably, the judgement module can further comprise:

a first classification unit configured to classify the obtained permissions applied for by the application program into privacy permissions for reminding the user of a special attention and other permissions to be authorized directly as the application program applies for.

In a practical application, the judgement module can further comprise:

a second classification unit configured to divide the privacy permissions into essential permissions essential to the running of the application program and nonessential permissions optional to the running of the application program, and display prompt information of the nonessential permissions to the user on an authorization setting interface.

As an optional embodiment, the judgement module can further comprise:

a verification unit configured to perform verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, removing the permission from the essential permissions and displaying it to the user as a nonessential permission.

As an optional embodiment, the apparatus can further comprise:

a displaying module configured to display the obtained behavior permissions applied for by the application program.

As another optional embodiment, the apparatus can further comprise:

a security scanning module configured to perform security scanning on an application program file package to be installed, and if the application program file package to be installed passes the security scanning, install the application program file package, otherwise end the flow.

In an embodiment of the invention, the security scanning comprises, but is not limited to, Trojan virus scanning, adware scanning and vulnerability scanning.

The algorithms and displays provided here are not inherently related to any specific computer, virtual system or other device. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

In the specification provided herein, a plenty of particular details are described. However, it can be appreciated that embodiments of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in an apparatus for installing an application program based on an intelligent terminal device according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

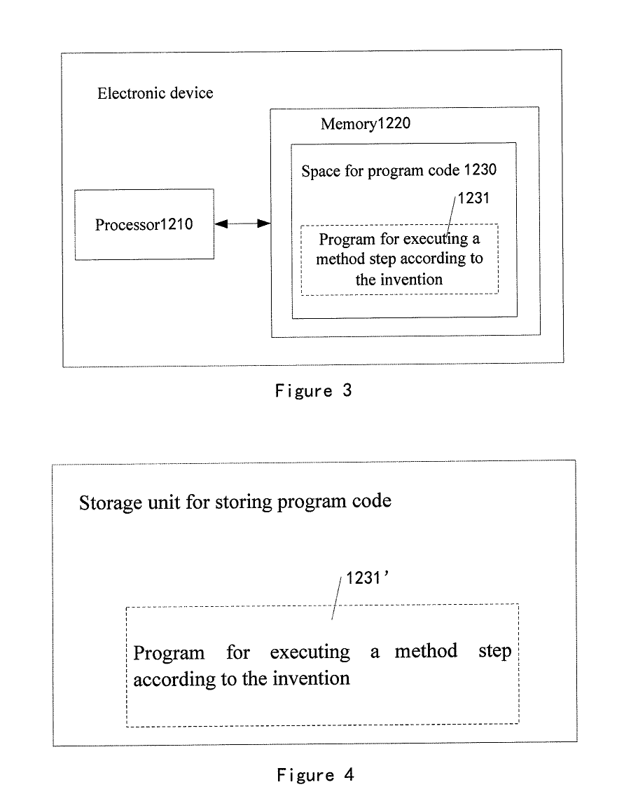

For example, FIG. 3 shows an electronic device which may carry out an access method for an application program of the invention. The electronic device traditionally comprises a processor 1210 and a computer program product or a computer readable medium in the form of a memory 1220. The memory 1220 may be an electronic memory such as a flash memory, an EEPROM (electrically erasable programmable read-only memory), an EPROM, a hard disk or a ROM. The memory 1220 has a memory space 1230 for a program code 1231 for carrying out any method steps in the methods as described above. For example, the memory space 1230 for a program code may comprise individual program codes 1231 for carrying out individual steps in the above methods, respectively. The program codes may be read out from or written to one or more computer program product. These computer program products comprise such a program code carrier as a hard disk, a compact disk (CD), a memory card or a floppy disk. Such a computer program product is generally a portable or stationary storage unit as described with reference to FIG. 6. The storage unit may have a memory segment or a memory space, etc. arranged similarly to the memory 1220 in the electronic device of FIG. 5. The program code may for example be compressed in an appropriate form. In general, the storage unit comprises a program 1231′ for executing method steps according to the invention, i.e., a code which may be read by e.g., a processor such as 1210, and when run by an electronic device, the codes cause the electronic device to carry out individual steps in the methods described above.

“An embodiment”, “the embodiment” or “one or more embodiment” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment. In the specification provided herein, a plenty of particular details are described. However, it can be appreciated that embodiments of the invention may be practiced without these particular details. In some embodiments, well known methods, structures and technologies are not illustrated in detail so as not to obscure the understanding of the specification.

It is to be noted that the detailed description of the invention in the above embodiments does not limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. An access method for an application program based on an intelligent terminal device, the method comprising:
after it is monitored that an installed application program performs a first access or an access that has ever been once denied of a behavior permission granted by an intelligent terminal device operating system, reading an application program authorization permission list preset for the application program by a user, wherein the behavior permission granted by the intelligent terminal device operating system is a behavior permission granted during the installation of the application program, and the application program authorization permission list comprises one or more behavior permission selectively authorized by the user for the application program;
judging whether the behavior permission of the first access or the access that has ever been once denied matches any behavior permission authorized in the application program authorization permission list; and
determining that the behavior permission of the first access or the access that has ever been once denied does not match any behavior permission authorized in the application program authorization permission list, denying to perform the first access or the access that has ever been once denied of the behavior permission granted by the intelligent terminal device operating system by the application program.

2. The method of claim 1, wherein the reading an application program authorization permission list preset for the application program by a user comprises:
parsing an application program file package corresponding to the application program to obtain an application program identifier in the application program file package; and
according to the obtained application program identifier, querying a preset application program authorization permission list library to obtain an application program authorization permission list corresponding to the application program identifier.

3. The method of claim 2, wherein setting the application program authorization permission list library comprises:
for each application program, collecting and obtaining behavior permissions applied for by the application program; and
according to behavior permissions authorized by the user from the obtained behavior permissions applied for by the application program, generating an application program authorization permission list stored in the application program authorization permission list library.

4. The method of claim 3, wherein the obtaining permissions applied for by the application program comprises:
obtaining an application program file package via an official download website of the application program; and
parsing a configuration information file in the application program file package to obtain behavior permissions need to be applied for by the application program.

5. The method of claim 4, wherein the parsing a configuration information file in the application program file package comprises:
decompressing an application program file based on the intelligent terminal device, obtaining an encrypted configuration information file described by a global variable from the decompressed application program file, decrypting the encrypted configuration information file to obtain a decrypted original configuration information file, and scanning a behavior permission description portion in the decrypted original configuration information file.

6. The method of claim 5, wherein an extensible markup language file parser in Java is used to parse the behavior permission description portion in the decrypted original configuration information file.

7. The method of claim 1, wherein each application program corresponds to an application program authorization permission list, a plurality of application program authorization permission lists constitute the application authorization permission list library, and the authorized behavior permissions comprised in the application program authorization permission list are part of behavior permissions granted by the intelligent terminal device operating system.

8. The method of claim 3, wherein before the according to behavior permissions authorized by the user from the obtained permissions applied for by the application program, the method further comprises:
displaying the obtained behavior permissions applied for by the application program.

9. The method of claim 3, wherein after the obtaining the behavior permissions applied for by the application program, the method further comprises:
classifying the obtained behavior permissions applied for by the application program into privacy permissions for reminding the user to pay special attention and other permissions to be authorized directly as the application program applies for.

10. The method of claim 9, wherein the method further comprises:
dividing the privacy permissions into essential permissions essential to the running of the application program and nonessential permissions optional to the running of the application program, selecting and updating the essential permissions and the nonessential permissions by the user, and displaying prompt information of the nonessential permissions to the user on an authorization setting interface.

11. The method of claim 10, wherein the method further comprises:
performing verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, removing the permission from the essential permissions and displaying it to the user as a nonessential permission.

12. The method of claim 1, wherein before it is monitored that an installed application program performs a first access of a behavior permission, the method further comprises:
performing security scanning on an application program file package to be installed, and if the application program file package to be installed passes the security scanning, installing the application program file package, otherwise, ending the flow.

13.-14. (canceled)

15. An access apparatus for an application program based on an intelligent terminal device, comprising:
a memory having instructions stored thereon;
a processor configured to execute the instructions to perform following operations:
after it is monitored that an installed application program performs a first access or an access that has ever been once denied of a behavior permission granted by an intelligent terminal device operating system, reading an application program authorization permission list preset for the application program by a user, wherein the behavior permission granted by the intelligent terminal device operating system is a behavior permission granted during the installation of the application program, and the application program authorization permission list comprises one or more behavior permissions selectively authorized by the user for the application program;
judging whether the behavior permission of the first access or the access that has ever been once denied matches any behavior permission authorized in the application program authorization permission list; and
determining that the behavior permission of the first access or the access that has ever been once denied does not match any behavior permission authorized in the application program authorization permission list, denying to perform the first access or the access that has ever been once denied of the behavior permission granted by the intelligent terminal device operating system by the application program.

16. The apparatus of claim 15, wherein the reading an application program authorization permission list preset for the application program by a user comprises:
parsing an application program file package for installing the application program to obtain an application program identifier in the application program file package; and
according to the obtained application program identifier, querying a preset application program authorization permission list library to obtain an application program authorization permission list corresponding to the application program identifier.

17. The apparatus of claim 16, wherein after the obtaining the behavior permissions applied for by the application program, the operations further comprise:
classifying the obtained permissions applied for by the application program into privacy permissions for reminding the user of a special attention and other permissions to be authorized directly as the application program applies for.

18. The apparatus of claim 17, wherein the operations further comprise:
dividing the privacy permissions into essential permissions essential to the running of the application program and nonessential permissions optional to the running of the application program, and display prompt information of the nonessential permissions to the user on an authorization setting interface.

19. The apparatus of claim 18, wherein the operations further comprise:
performing verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, removing the permission from the essential permissions and displaying it to the user as a nonessential permission.

20. The apparatus of claim 15, wherein before the according to behavior permissions authorized by the user from the obtained permissions applied for by the application program, the operations further comprise:
displaying the obtained behavior permissions applied for by the application program.

21. The apparatus of claim 17, wherein before it is monitored that an installed application program performs a first access of a behavior permission, the operations further comprise:
performing security scanning on an application program file package to be installed, and if the application program file package to be installed passes the security scanning, installing the application program file package, otherwise ending the flow.

22. (canceled)

23. A non-transitory computer readable medium having instructions stored thereon that, when executed by at least one processor, cause the at least one processor to perform following operations:
after it is monitored that an installed application program performs a first access or an access that has ever been once denied of a behavior permission granted by an intelligent terminal device operating system, reading an application program authorization permission list preset for the application program by a user, wherein the behavior permission granted by the intelligent terminal device operating system is a behavior permission granted during the installation of the application program, and the application program authorization permission list comprises one or more behavior permission selectively authorized by the user for the application program;
judging whether the behavior permission of the first access or the access that has ever been once denied matches any behavior permission authorized in the application program authorization permission list; and
determining that the behavior permission of the first access or the access that has ever been once denied does not match any behavior permission authorized in the application program authorization permission list, denying to perform the first access or the access that has ever been once denied of the behavior permission granted by the intelligent terminal device operating system by the application program.
